(19) United States
(12) Patent Application Publication
(10) Pub. No.: US 2013/0268871 A1
(43) Pub. Date: Oct. 10, 2013

(54) Color Shop Website

(71) Applicants: Marc Webb, Orange, CA (US); Joseph Thomas Richardson, Santa Ana, CA (US)

(72) Inventors: Marc Webb, Orange, CA (US); Joseph Thomas Richardson, Santa Ana, CA (US)

(21) Appl. No.: 13/564,606

(22) Filed: Aug. 1, 2012

Related U.S. Application Data
(60) Provisional application No. 61/621,132, filed on Apr. 6, 2012.

(51) Int. Cl. G06F 3/0482

(52) U.S. Cl. CPC G06F 3/0482
USPC 715/760

(57) ABSTRACT

A color selection and coordination website wherein selection of one of various different “room type” links generates a display comprising a scene of the room and a display beneath the scene of a row of color chips, each providing a “quick view” link, which when selected causes generation of (a) a display of an enlarged color chip having the color selected, (b) an adjacent room scene, and (c) a “view in a room” link located beneath the adjacent room scene. Selection of the “view in a room” link generates a display comprising an interior room scene and an exterior home scene, each painted with the color of the color chip and a row of five interior thumb images and five exterior thumb images, any one of which, when selected, will replace the originally displayed interior and exterior scenes.

### CROSS REFERENCE TO RELATED APPLICATIONS

This application claims the benefit of and priority to U.S. Provisional Application Ser. No. 61/621,132, filed Apr. 6, 2012, entitled “Color Shop Website,” the contents of which is incorporated by reference herein in its entirety.

### FIELD

The subject disclosure relates to systems which provide color selection, coordination, and/or purchase capability and more particularly to websites facilitating selection and purchase of paint or other coating products.

### RELATED ART

Architectural paint (“house paint”) is commonly provided in various colors. Paint color display systems have been developed to display various paint color samples to assist consumers in selecting paint colors. Most recently, automated computer or web-based color selection, coordination, and/or purchase systems have been provided.

### SUMMARY

In an illustrative embodiment, a computerized method is provided for assisting a user with color selection via selection operations performed on a computer controlled display wherein a user is presented with a first display screen which comprises a home page having first, second, and third links located adjacent one another along an upper edge thereof. One of the first, second, and third links comprises an “expert picks” link responsive to a user selection operation to cause generation of a drop down menu comprising a plurality of links to various different room types.

User selection of one of the various different “room type” links generates a display comprising a scene of the room and a display beneath the scene of a row of color chips each having a different color. Each of these color chips, when subjected to a touch or selection operation, displays a “quick view” link, which when selected, causes generation of a display which includes an enlarged color chip having the color selected, an adjacent room scene, a “view in a room” link located beneath the adjacent room scene, and a “buy now” link.

In one embodiment, in response to selection of the “view in a room” link, a “view in a room” display screen is generated, which in one embodiment comprises: (a) a generally rectangular color chip of the initially selected color, (b) an interior room scene adjacent the color chip, wherein one or more surfaces are shown painted with the color of the color chip, (c) an exterior scene adjacent the interior scene wherein one or more exterior surfaces of a home image are painted with the color of the color chip, (d) a row of five interior thumb images, and (e) a row of five exterior thumb images, each row disposed beneath the interior and exterior images. In one embodiment, each of the thumb images comprises a link, which, when selected or “clicked on”, causes the selected thumb image to enlarge and replace the image shown in one of the respective interior and exterior scenes.

### DESCRIPTION OF THE DRAWINGS

FIG. 1 is a schematic block diagram of apparatus useful in implementing illustrative embodiments;

FIGS. 2 and 3 illustrate a home web page or display screen of an illustrative embodiment;

FIG. 4 illustrates the web page of FIGS. 2 and 3 after an “expert picks” link has been selected;

FIGS. 5 and 6 illustrate a page or display presented or generated in an illustrative embodiment when a user selects the bedroom link of the “expert picks” drop down menu;

FIG. 7 illustrates a page or display presented or generated in an illustrative embodiment after selecting a “quick view” link;

FIG. 8 illustrates a page or display presented or generated in an illustrative embodiment after selecting a “view in a room” link shown in FIG. 7;

FIGS. 9-12 illustrate a page or display presented or generated in an illustrative embodiment of respective enlarged interior room images which may be displayed in response to selection operations performed in conjunction with the screen or page of FIG. 8;

FIGS. 12-15 illustrate a page or display presented or generated in an illustrative embodiment of respective enlarged exterior room images which may be displayed in response to selection operations performed in conjunction with the screen or page of FIG. 8

FIG. 16 illustrates a web page or screen presented or generated in response to selecting an area of a color chip other than a quick view link;

FIG. 17 illustrates a web page or screen presented or generated in response to selecting a “Reds” link on the “expert picks” drop down menu;

FIGS. 18 and 19 illustrate pages or screens respectively presented or generated in response to selection of Interior or Exterior links of the “expert picks” drop down menu;

FIG. 20 illustrates a page or screen presented or generated in response to selection of a “browse colors” link;

FIG. 21 illustrates a page or screen presented or generated in response to selection of a “Reds” color family link or the screen on page of FIG. 20;

FIG. 22 illustrates a page or screen presented or generated in response to selection of a “styles and ideas” link;

FIG. 23 illustrates a page or screen presented or generated in response to selection of a room image link;

FIG. 24 is a schematic diagram illustrating apparatus useful in implementing illustrative embodiments.

### DETAILED DESCRIPTION

### Website System Environment

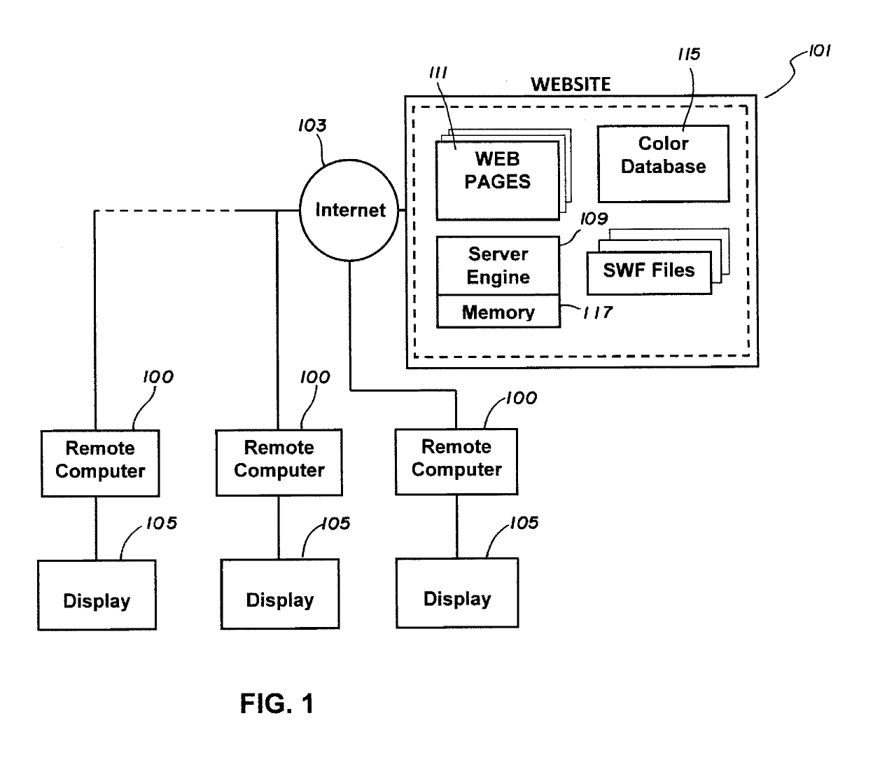

FIG. 1 illustrates a block diagram of a system in which multiple remote computers 100 may access a paint color selection and coordination website 101. The website 101 may be coupled to the Internet 103 in order to provide access to a large number of remote terminals/computers 100, for example, at in-home end user sites. Each remote computer 100 controls a display apparatus 105, which may comprise, for example, one or more CRTs or flat screen computer monitors or displays.

The website 101 may comprise a server engine 109 comprising one or more computers, or servers, associated memory 117 and server software such as a server operating system and server application programs. The website 101 is arranged to store and transmit a plurality of related documents or web pages 111 in digital format, for example, such as HTML documents, and, in some embodiments, may further include a color data base 115 where color data is stored as described, for example, in U.S. Patent App. Pub. No. U.S. 2006/0001677 A1, incorporated herein by reference in its entirety. It will be appreciated that the computer controlled display apparatus transforms the digital format web pages into static and/or animated interactive visual images for an end user. The associated memory 117 may comprise a tangible computer readable digital storage media or medium, such as, for example, hard disc storage.

A user may interact with the website 101 over the Internet 103 or other communication medium or media via selection operations performed on web page display screens presented to the user via the display apparatus 105 of a remote computer 100. Such selection operations may be performed by, for example, a keyboard, mouse, track ball, touch screen or other data entry means. In such a manner, various links presented on the display apparatus 105 may be selected by various point and click, point and touch, finger touch, or other selection operations.

In various embodiments, remote computers 100 may comprise or form part of a computer terminal, a personal digital assistant (PDA), a wireless telephone, a “smart phone”, a laptop, desktop or notebook computer, and/or the like. In various embodiments, the communications medium or media may comprise a local area network (LAN) a wide area network (WAN), a wireless network, an intranet, an internet, and/or the like.

In one embodiment, website functionality may be implemented in software stored on a computer readable storage medium or media and executed by a suitable device, for example, such as one or more digital processors or computers, which may comprise part of a web server or other suitable apparatus. Illustrative screens and functionality of an illustrative embodiment may be implemented in one or more application programs, which may be written in, for example, PHP, MySQL, JavaScript, XMPP Server, Solr Server, LAMP technology stack, Java, Laszlo Presentation Server or C++ and, which may run, for example, on a Windows XP or other operating system. Various display screens and functionality of illustrative embodiments will now be described.

### Color Selection Website Navigation

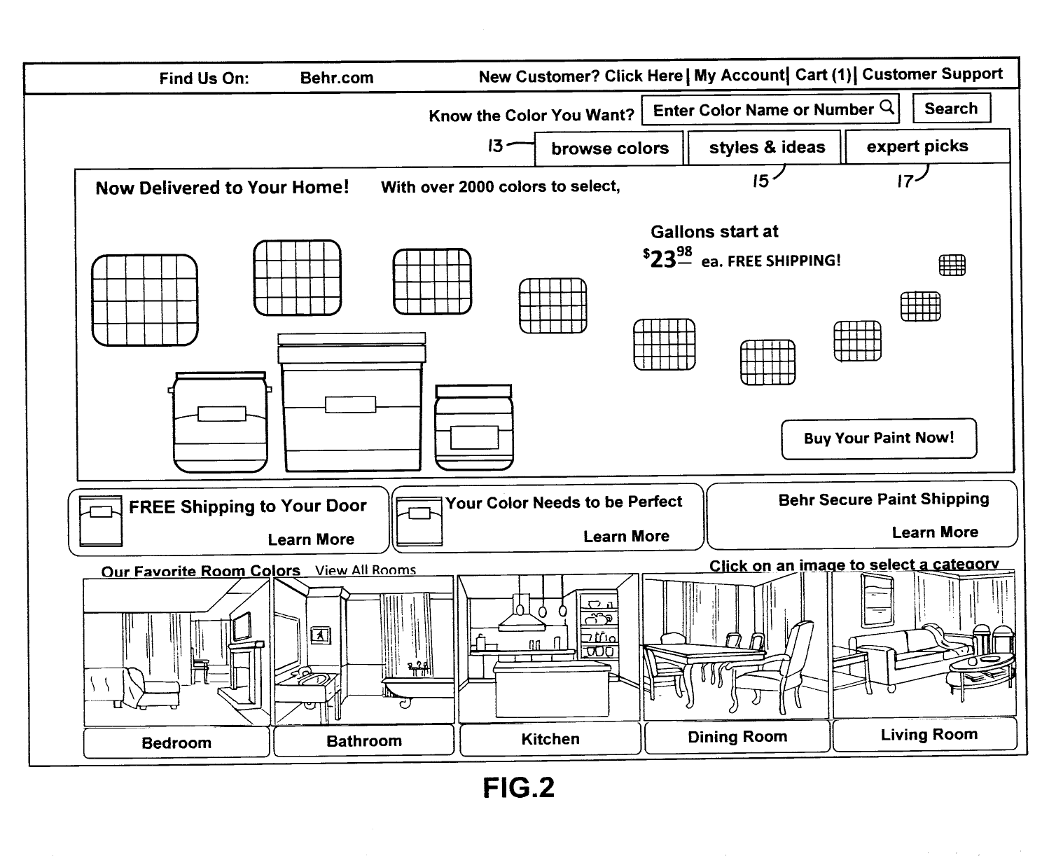

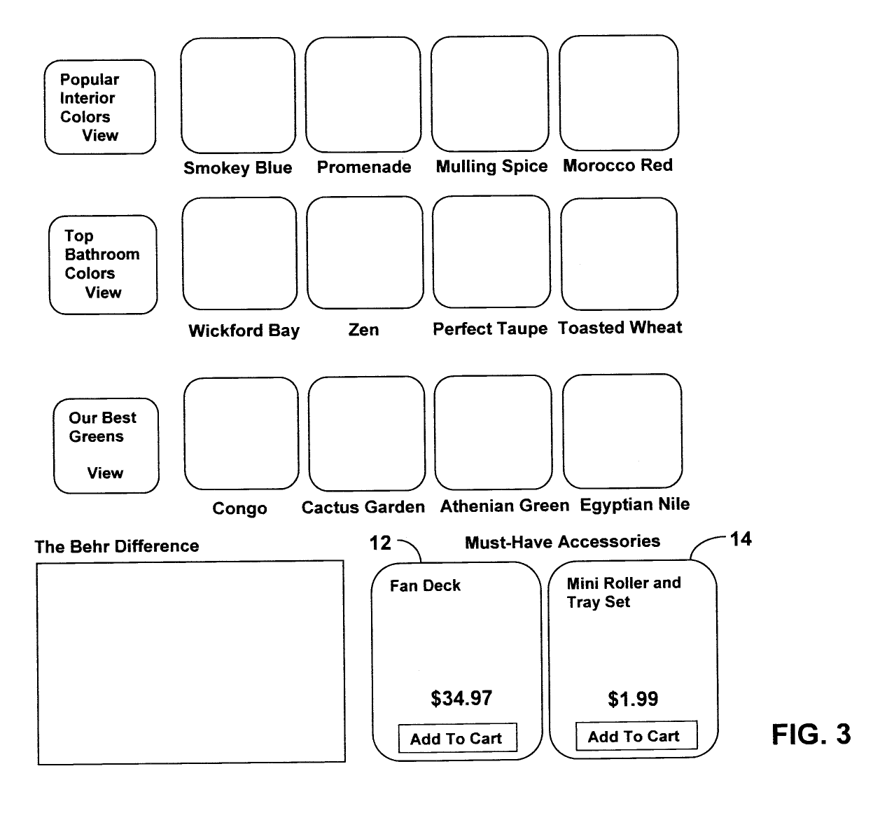

FIGS. 2 and 3 illustrate a home page 11 of an illustrative embodiment, which may, for example, be displayed on a display 105 of FIG. 1. The home page 11 provides three main links: “browse colors” 13, “styles and ideas” 15, and “expert picks” 17. The navigational paths from these links 13, 15, 17 are discussed below. In one embodiment, FIGS. 2 and 3 appear in the same screen with FIG. 2 being first displayed to the user and FIG. 3 being brought into view by scrolling down the screen. FIG. 2 provides a plurality of color chips 12 for various colors, e.g., “Smokey Blue,” as well as a color fan deck and a mini roller and tray links 12, 14, which can be selected to initiate purchase of decorating-related items such as a color fan deck.

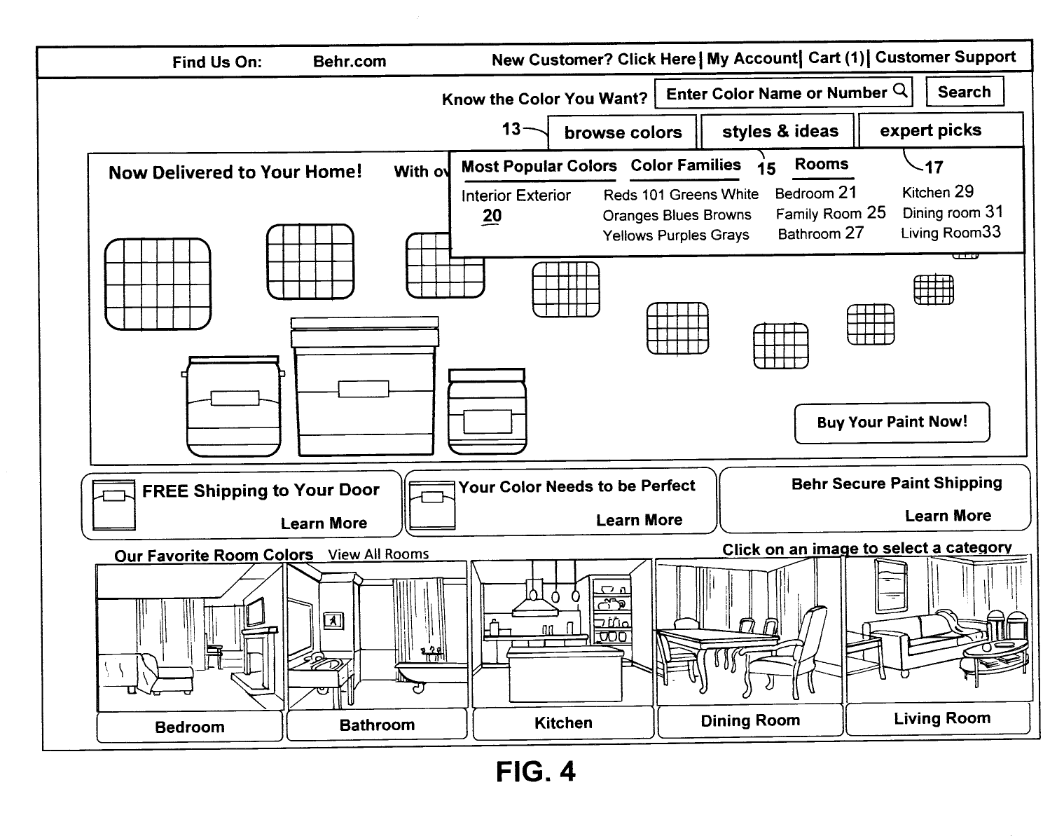

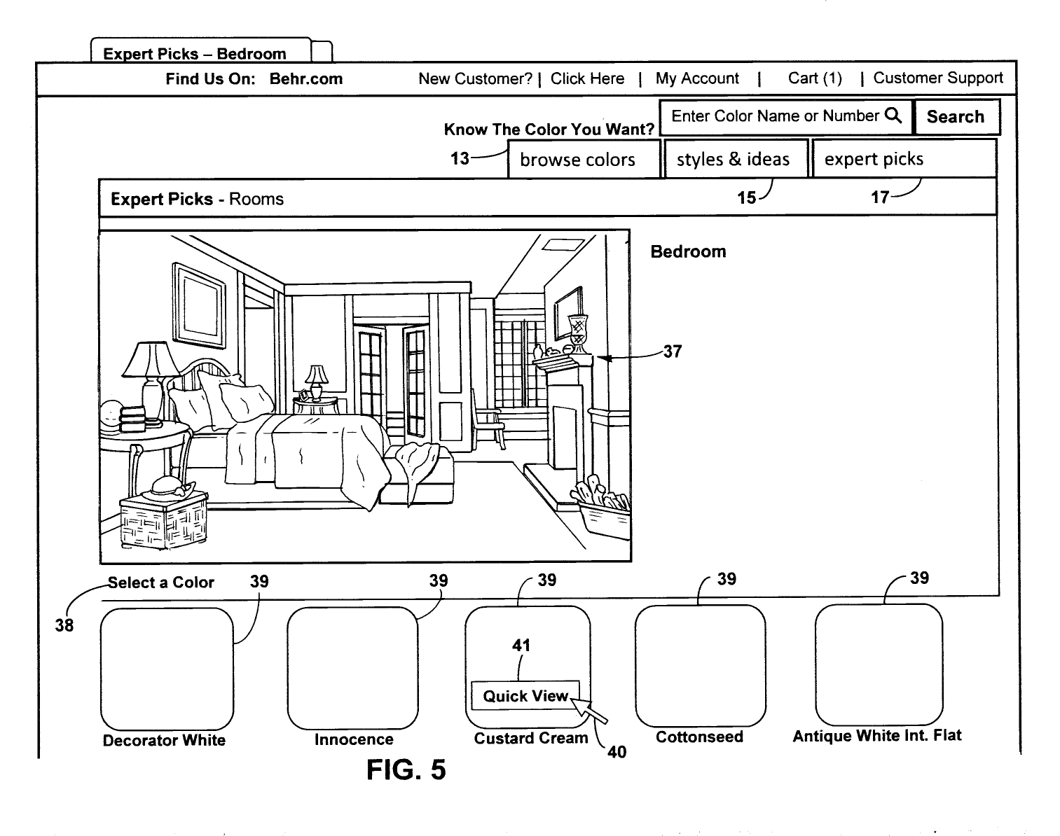

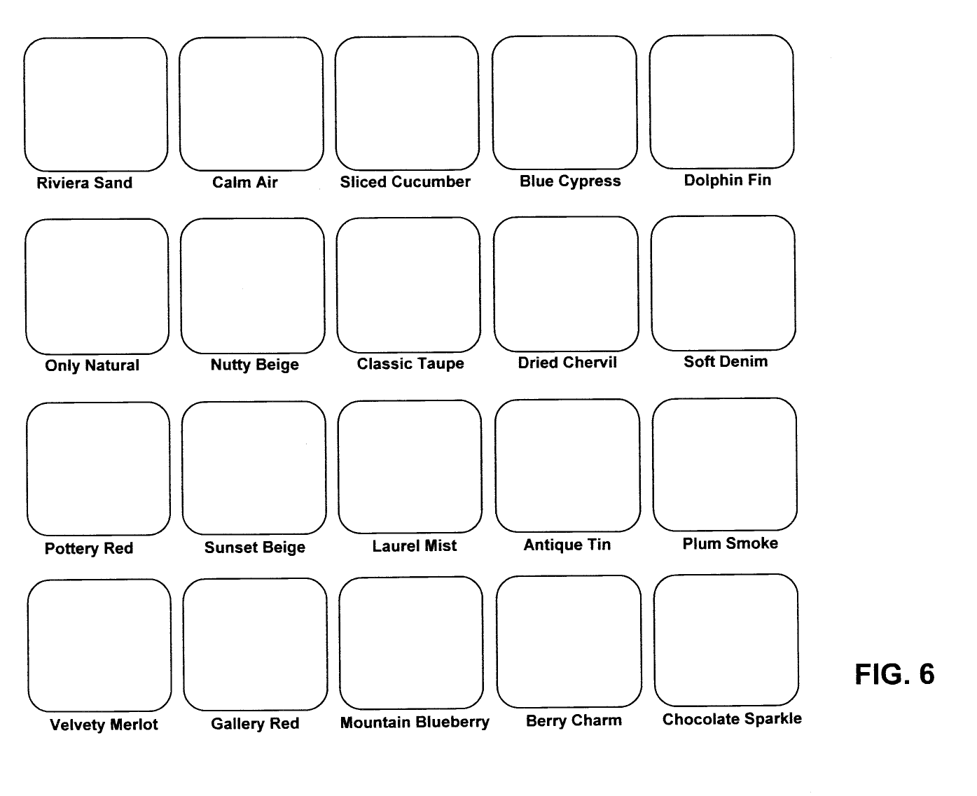

Clicking on the home page “expert picks” link 17 produces a drop down menu 20 shown in FIG. 4, which includes a number of links enabling selection, among other things, of one of a number of respective rooms: bedroom link 21, family room link 25, bathroom link 27, kitchen link 29, dining room link 31, and living room link 33. Clicking on the “bedroom” link 21, for example, produces a bedroom scene 37 as shown in FIGS. 5 and 6. In one embodiment, FIGS. 5 and 6 appear in the same screen with FIG. 5 being first displayed to the user and FIG. 6 being brought into view by scrolling down the screen.

Below the bedroom scene 37 are displayed five rows of five color chips, e.g., 39 and an instruction link 38 to “Select a Color.” Touching anyone of the color chips 39, e.g., the “custard cream” chip, causes appearance of a “quick view” link 41. Clicking on a “quick view” link, e.g., 41, on any one of the twenty five color chips, e.g., 39 of FIGS. 5 and 6 enables performance of a “quick view” sequence as hereafter described in more detail.

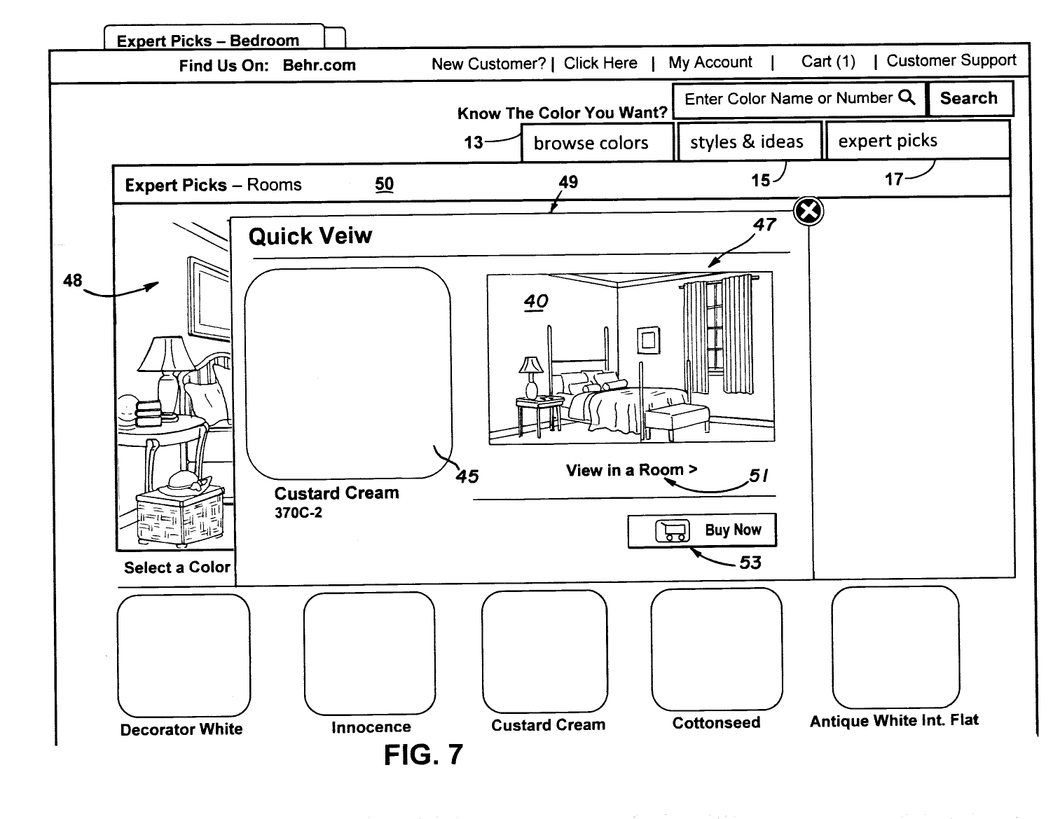

Specifically, as noted, placing the cursor 40 on one of the paint chips 39 causes a “quick view” link 41 to appear. Clicking or otherwise selecting this “quick view” link 41 leads to another display screen 50, illustrated in FIG. 7, which shows an enlarged paint chip 45 with an adjacent picture 47 of a room 40 painted with the color of the enlarged paint chip 45. In the embodiment illustrated in FIG. 7, the enlarged paint chip 45 and room 40 appear in a white rectangle background 49 overlaid upon a muted or diffused view 48 of the screen of FIG. 5. In the embodiment of FIG. 7, the room 40 is a bedroom, continuing the theme selected on the “expert picks” menu 21.

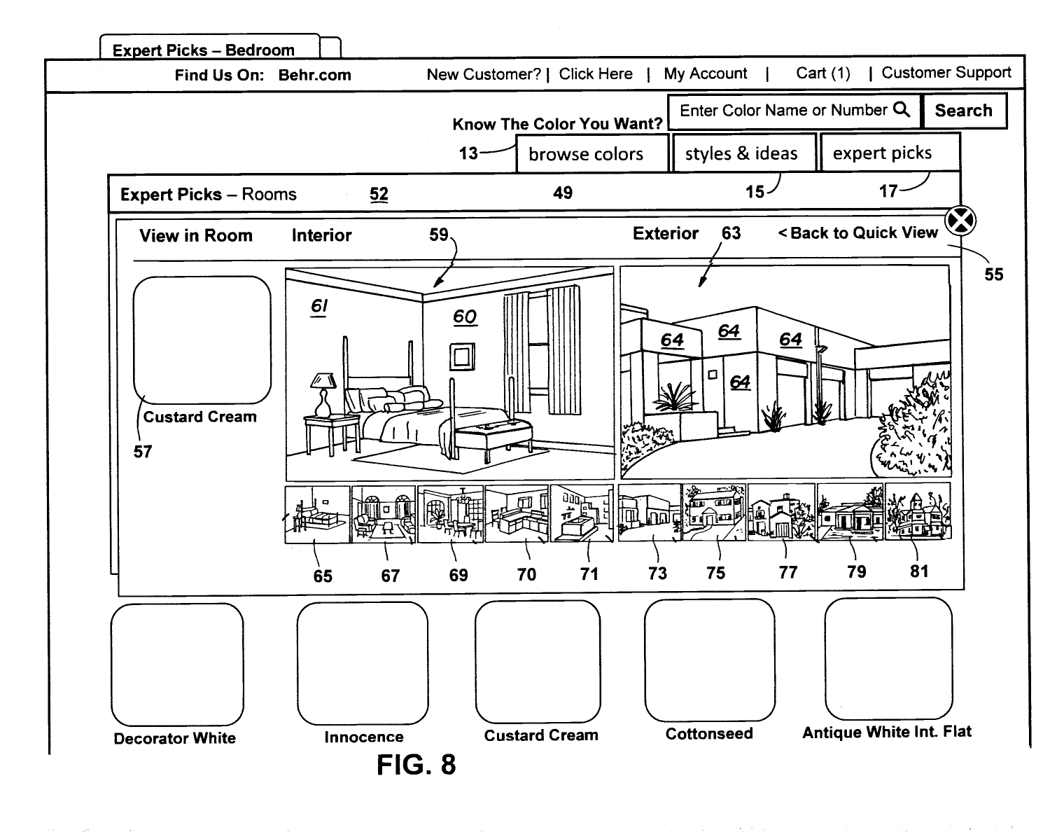

Beneath the image of the painted room 47 in FIG. 7 is a “view in a room” link 51, and a “buy now” link 53. Clicking or otherwise selecting the former link 51 brings up a “view in a room” screen 52 shown in FIG. 8, which permits the user to view the selected color applied to any one of five different interior rooms and any one of five different exterior home styles (modern, colonial, Mediterranean, ranch and Victorian). One may navigate from the screen of FIG. 8 back to the “quick view” screen 50 by clicking a link 55. The “Buy Now” link 53 is present to initiate a sequence of screens enabling the user to purchase paint of the displayed or selected color.

The “View in a Room” screen 52 of FIG. 8 includes a generally rectangular paint chip 57 of the color initially selected for a “quick view” on the “Expert picks” bedroom display 37 of FIG. 5, in this case, the color “custard cream.” Adjacent the color chip 57 is an interior bedroom scene 59, wherein, for example, the main vertical walls 60, 61 are shown painted with the color of the color chip 57, in this case “custard cream.” Adjacent the interior scene 59 is an exterior scene 63 wherein the exterior vertical surfaces, e.g., 64, of a home are painted with the color of the color chip 57. Beneath the large interior and exterior images 59, 63 is a row of five interior thumb images 65, 67, 69, 70, 71 and a row of five exterior thumb images 73, 75, 77, 79, 81. Each of these thumb images 65, 67, 69, 70, 71, 73, 75, 77, 79, 81 comprises a link, which when selected or “clicked on” causes an enlarged version of the selected thumb image 65, 67, 69, 70, 71, 73, 75, 77, 79, 81 to replace the large image shown in respective scenes 59, 63.

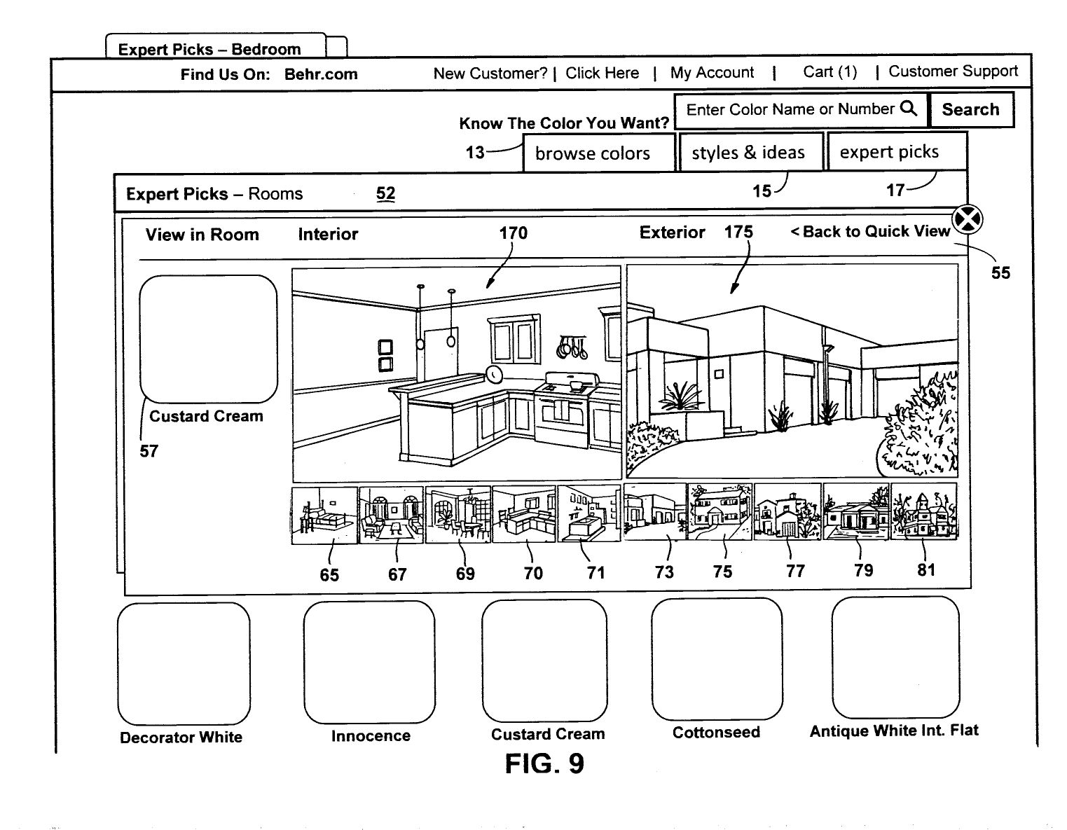

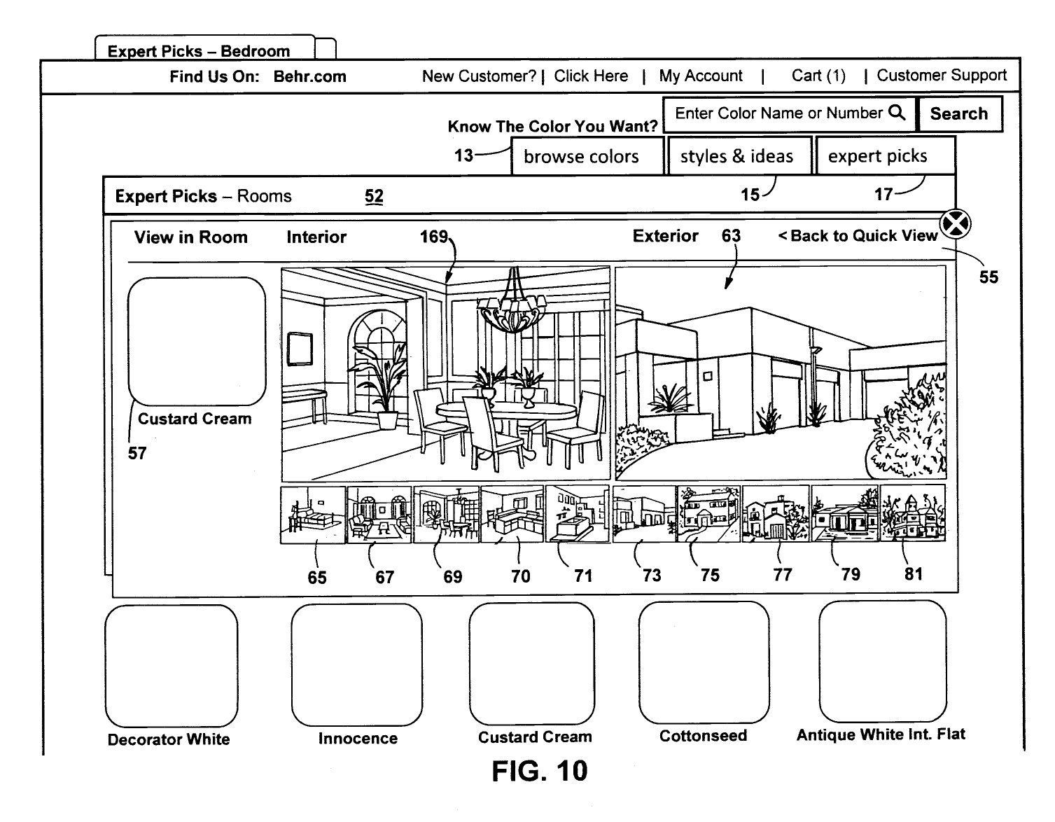

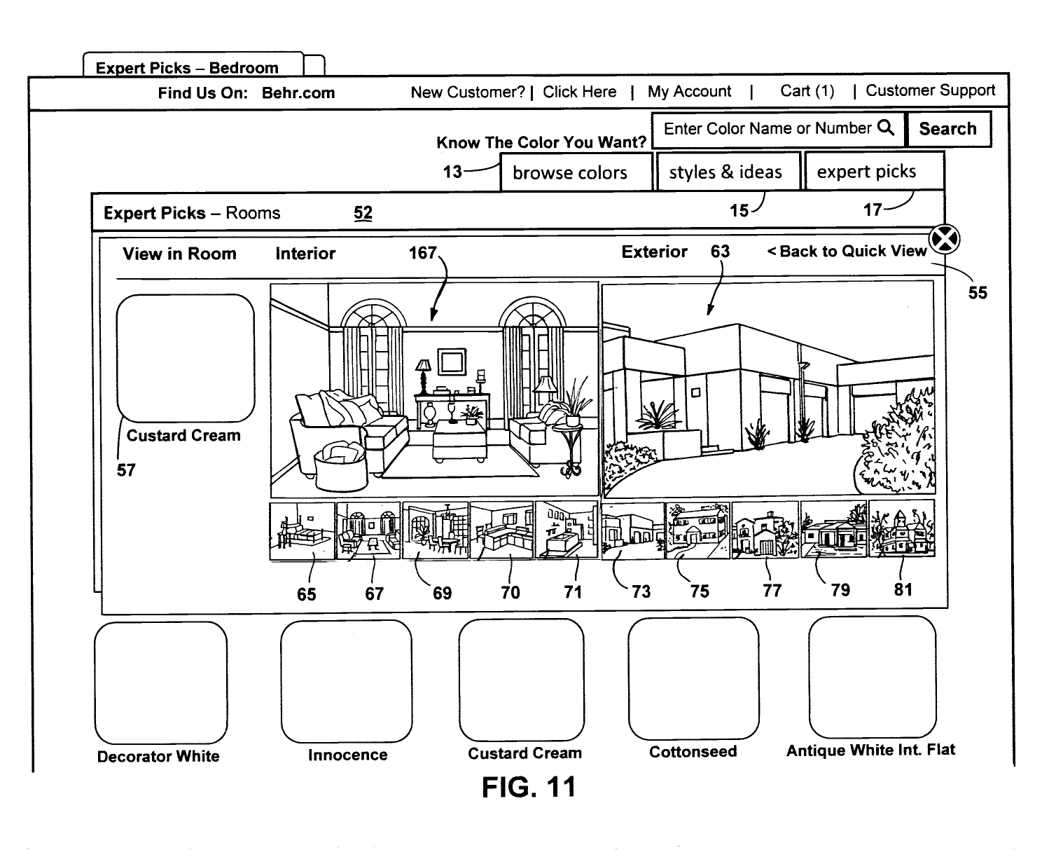

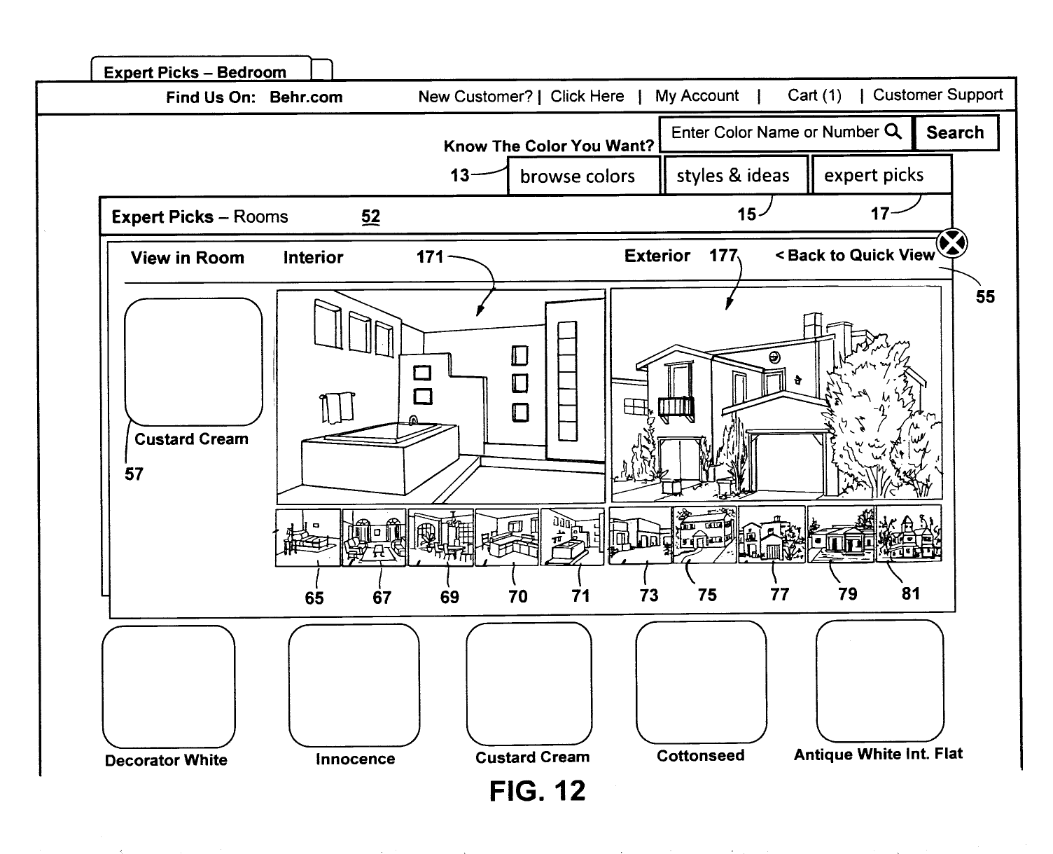

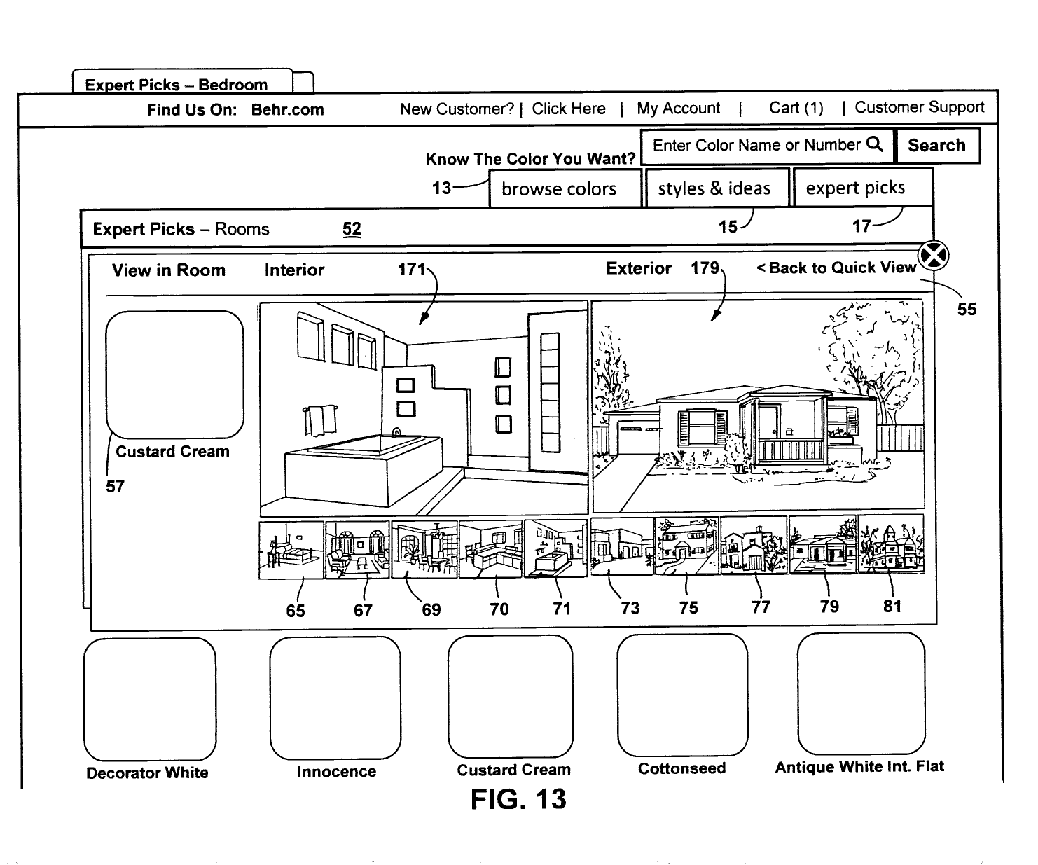

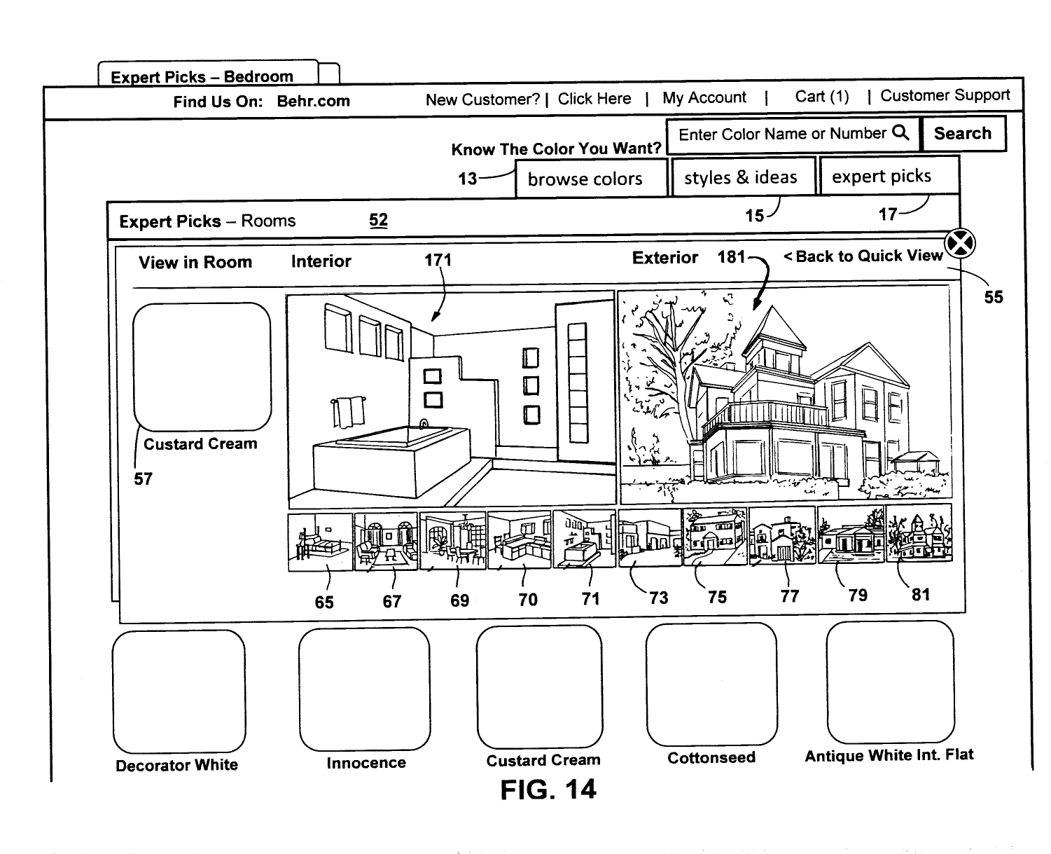

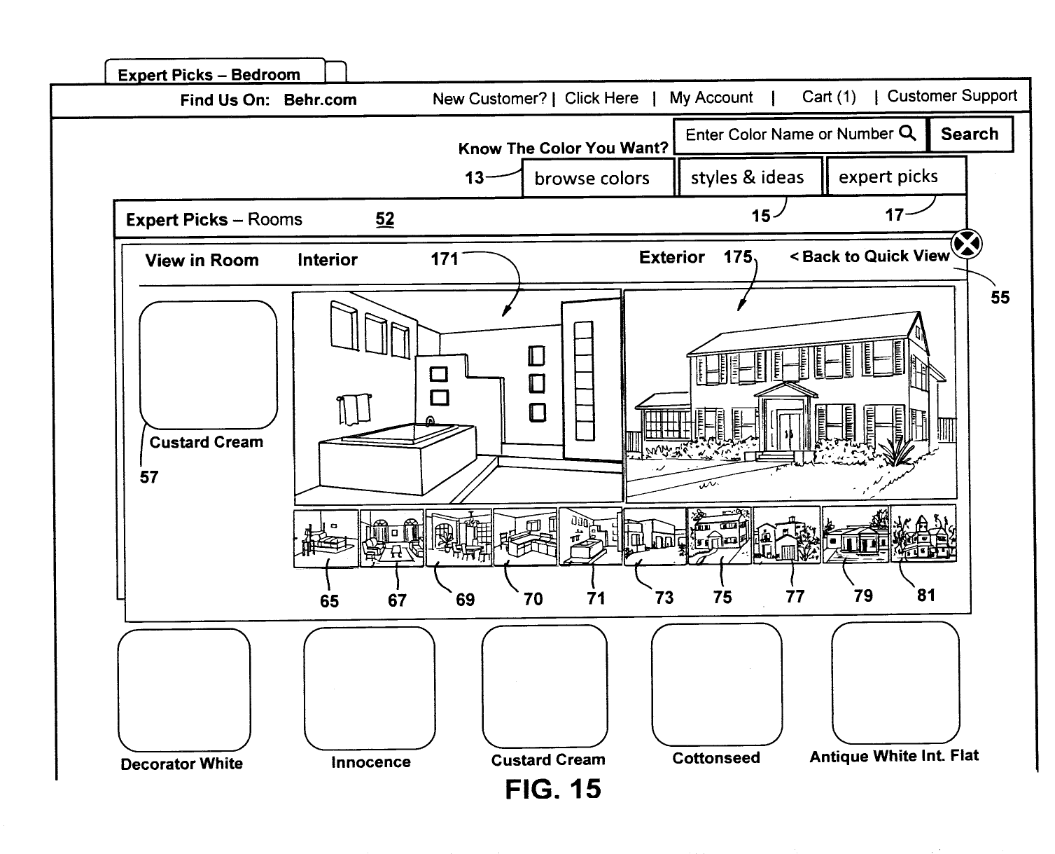

As noted, each enlarged thumb image e.g., 51, 63 has walls or surfaces painted with the selected “quick view” color chip 57. FIGS. 9-13 show the respective enlarged interior images of a kitchen 170, a dining room 169, a living room 167, and a bathroom 171. FIGS. 12-15 show the respective enlarged exterior images of a Mediterranean theme 177, ranch theme 179, Victorian theme 181, and colonial theme 175.

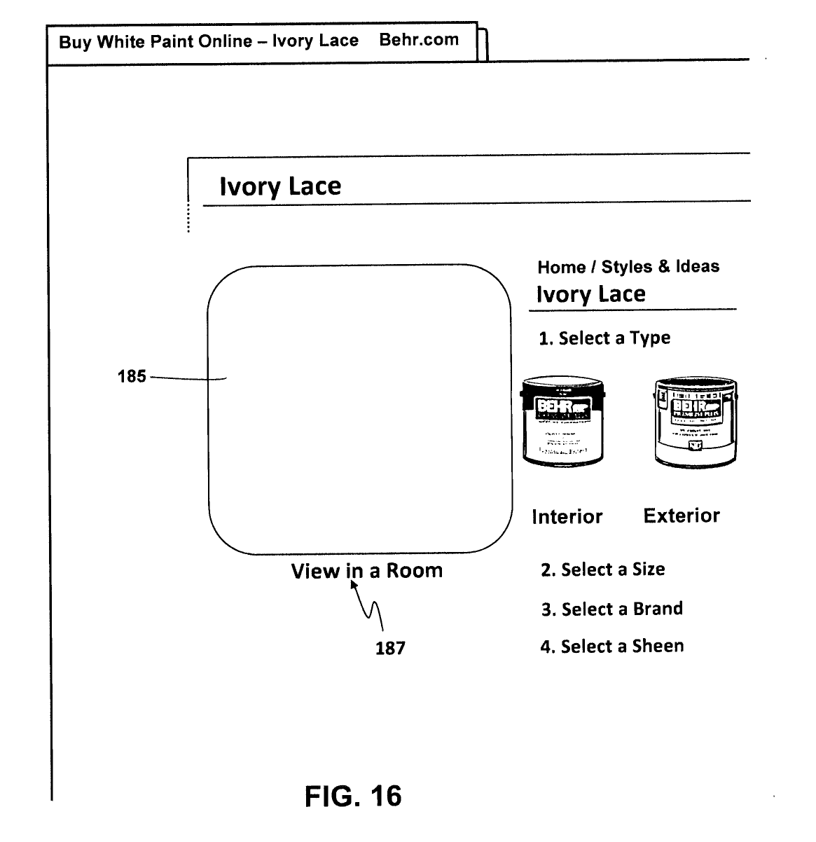

In one illustrative embodiment, if the cursor or other selector, for example, a finger on a touch screen, is placed on a color chip, e.g., 39, in an area other than a “quick view” link 41, a click or select operation will cause display of a screen or webpage as shown in FIG. 16, which displays an enlarged paint chip 185 of the selected color along with links permitting selection of a type, size, brand and sheen of the paint desired to be ordered. In one embodiment, after completing selection of each of these items, the customer's selection may be added to a shopping cart for ultimate check out, purchase, and delivery. A “View in a Room” link 187 is provided beneath the enlarged color chip 185, which when selected leads to a display screen like that of FIG. 8.

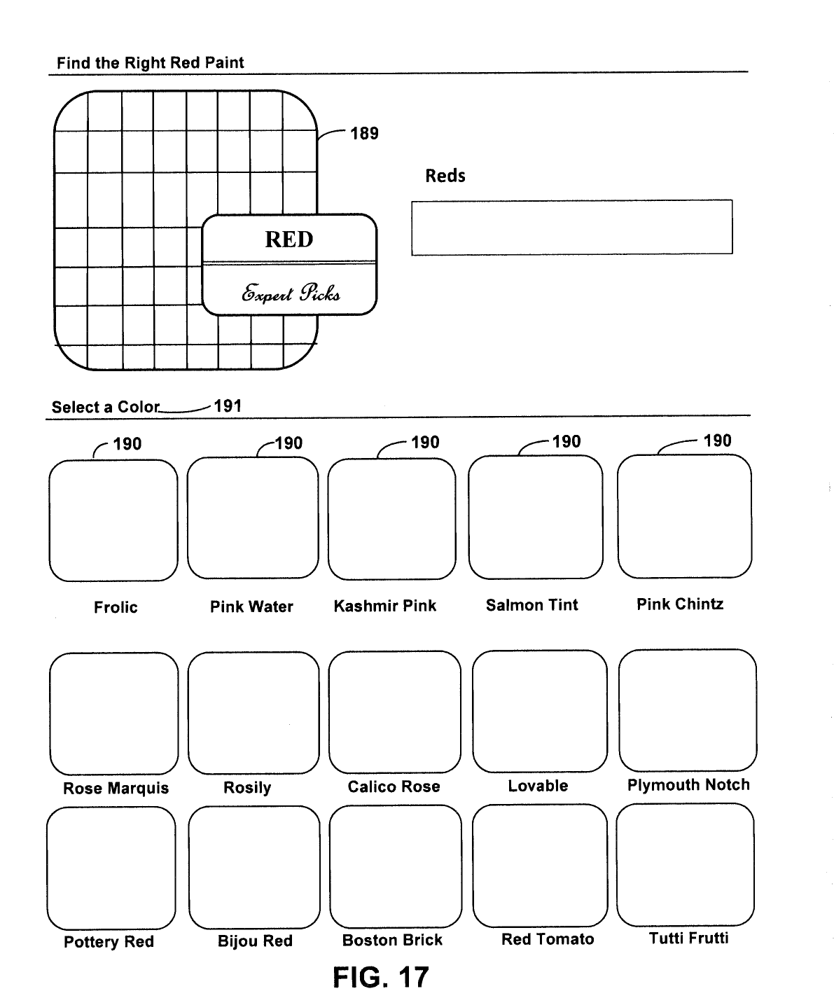

FIG. 17 illustrates a display screen or web page generated when a user selects the “Reds” link 101 beneath “Color Families” in the “expert picks” drop down menu 21 of FIG. 4. The display of FIG. 17 includes a palette 189 of red shades and beneath the phrase “Select a Color” includes, for example, five rows of five color chips, e.g., 190, each color chip comprising a different shade of red. Selecting any one of the other “Color Families” links on the drop down menu 21 of FIG. 4 may generate a similar display of twenty five shades of colors within the selected color family.

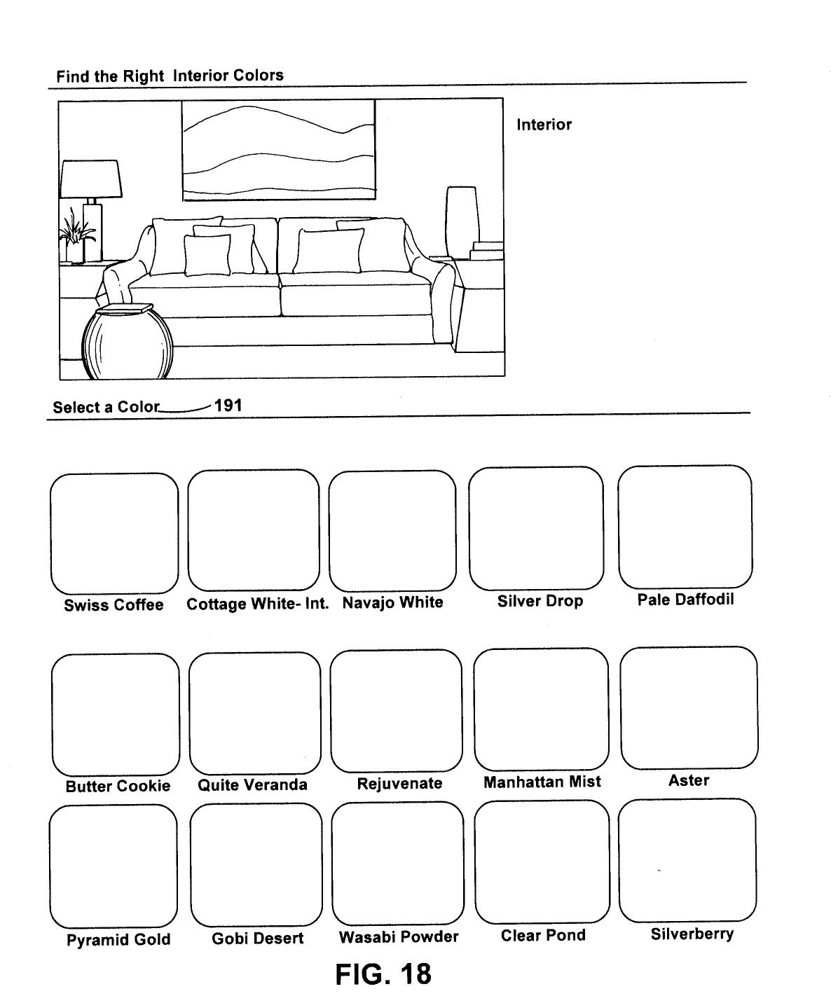

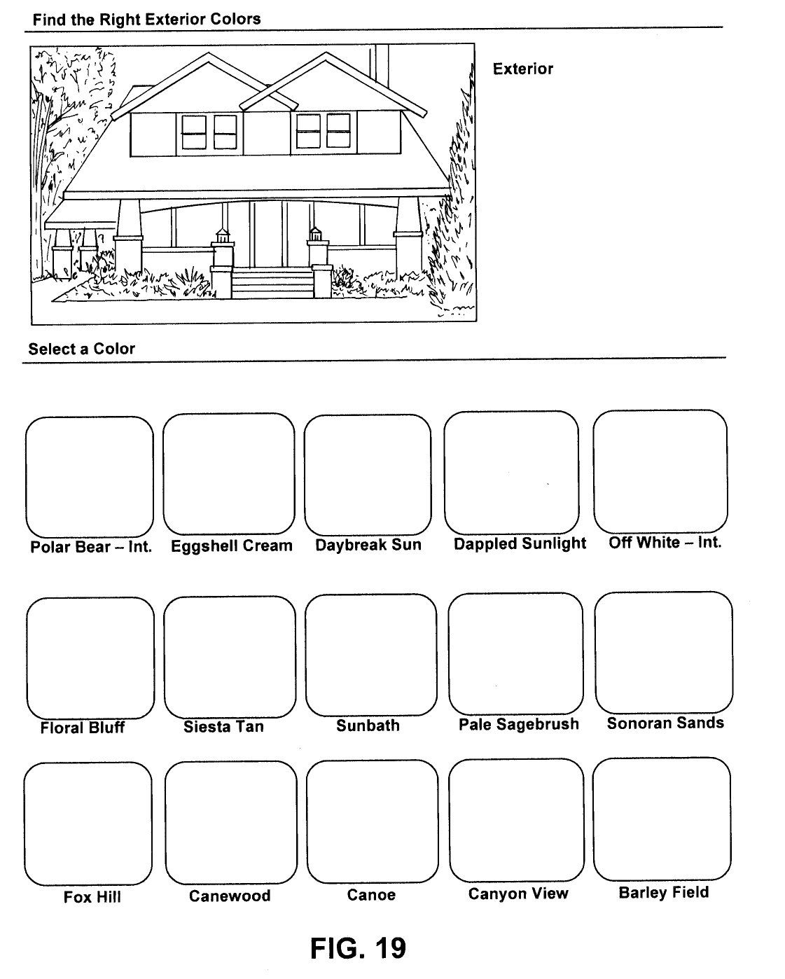

In one embodiment, selecting either the “Interior” or the “Exterior” link under “Most Popular” colors in the “expert picks” drop down menu 21 of FIG. 4 causes respective generation of the displays or web pages shown in FIGS. 18 and 19, each including a respective interior or exterior scene and a “Select a Color” link 191 instruction beneath which may be depicted 5 rows of 5 selectable paint chips each having a specially selected interior or exterior color. In one embodiment, each color chip may provide a quick view link or purchase links as discussed above.

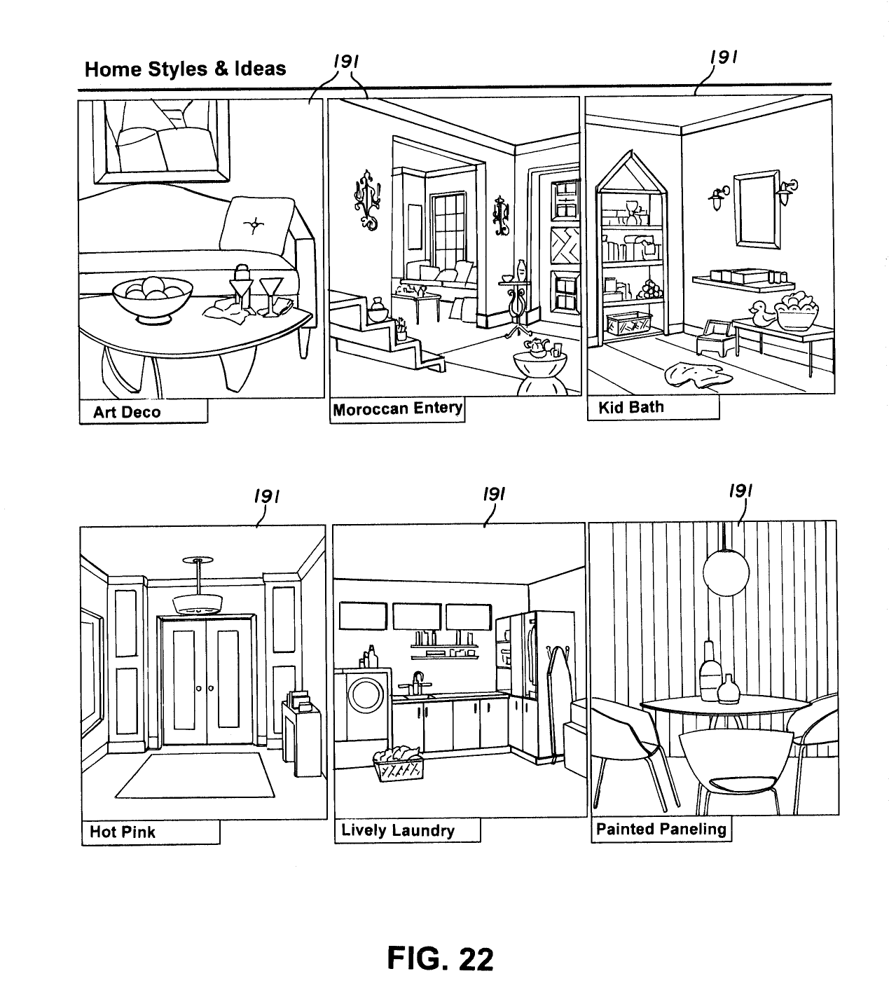

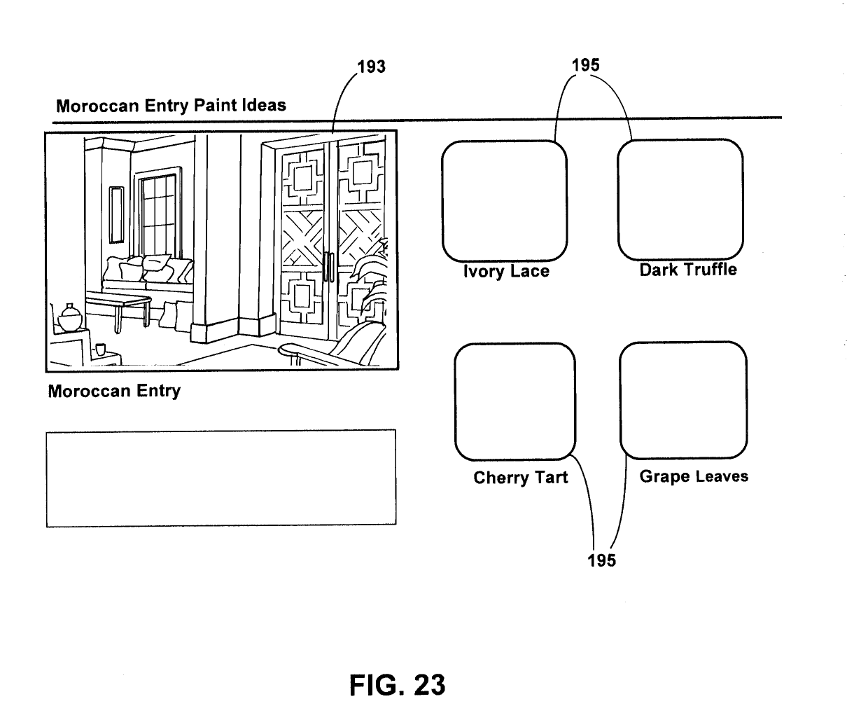

Touching the home page “styles and ideas” link 15 of FIG. 2 causes a display of a drop down menu which shows six different room images, e.g., those room images 191 shown in FIG. 22, each having a different style or motif and each with a “catchy” paint color combination: art deco, Moroccan entry, kids bath, hot pink, lively laundry, painted paneling. Clicking on the link 15 causes display of the screen shown in FIG. 22, with links for each room image. Clicking on one of these room image links brings up an enlarged view 193 of the room shown in FIG. 23, with four adjacent paint chips 195 - each chip 195 showing one of the colors used to paint various portions of the room, for example, trim, wall, and accent colors and an associated white. Each paint chip 195 may have the dual functionality of the chips 39 of FIG. 5. Thus, clicking on a “quick view” link 41 on one of the chips enables performance of the “quick view” sequence described above.

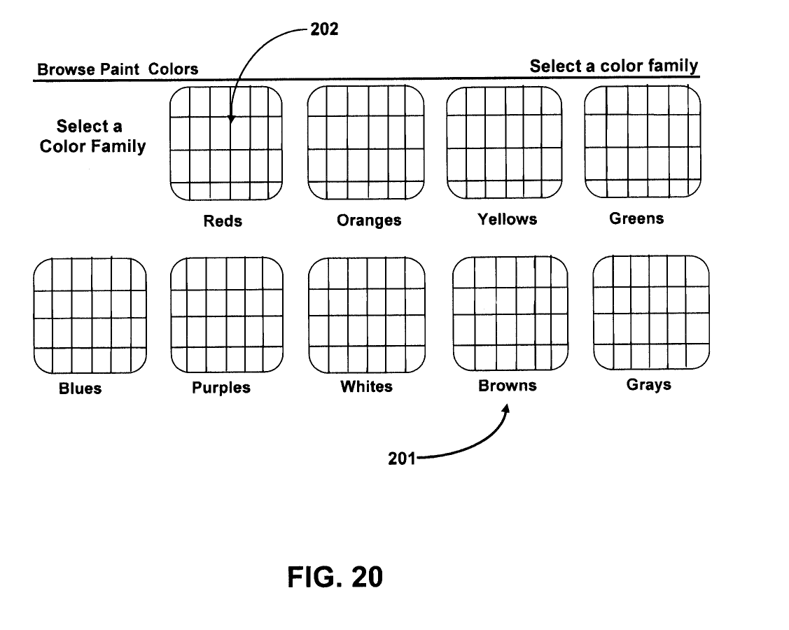

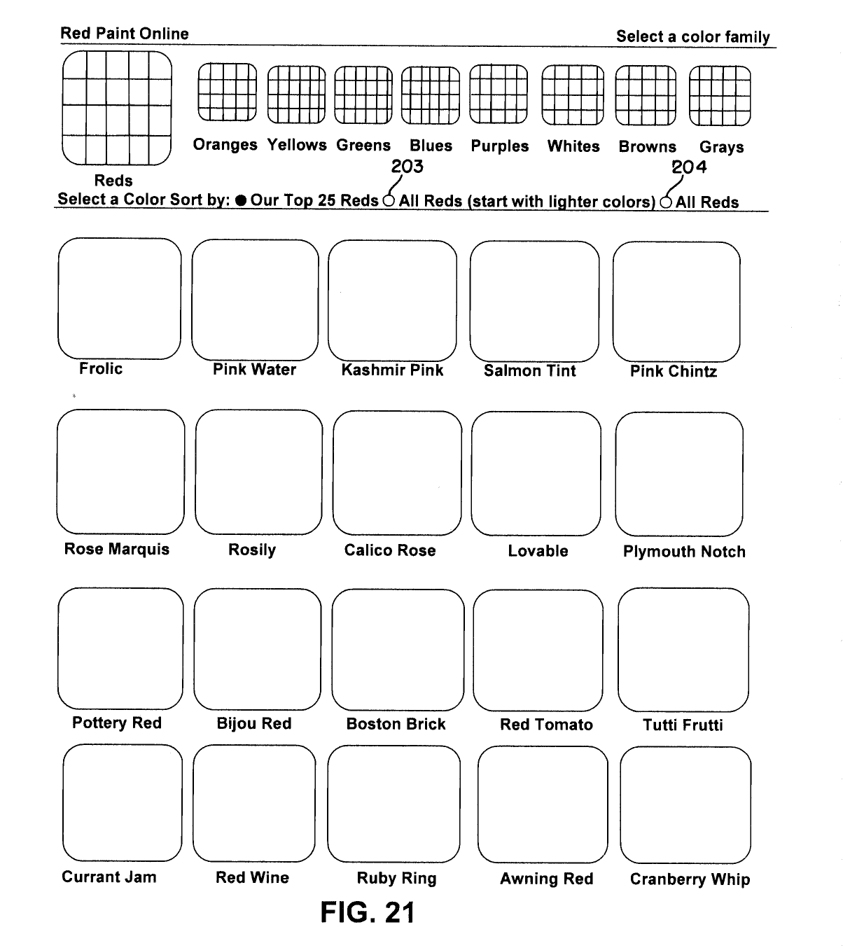

Touching the “browse colors” link 13 on the home page 11 of FIG. 2 causes a display of a drop down menu 201 of nine selectable color families, as shown in FIG. 20. Clicking on the “Reds” color family 202, for example, brings up a screen, FIG. 21, which has a palette of “our top 25 reds”. This screen of FIG. 21 displays five rows, each containing five different “red” color chips, each chip about one inch square. The screen of FIG. 21 also enables displaying paint chips of ‘all reds” by selecting one of links 203, 204, starting with either the darkest or lightest reds. Clicking directly on the “Browse Colors” link 13 of FIG. 2 causes display of a similar color family in one embodiment.

### Additional Website Structure and Programming Aspects

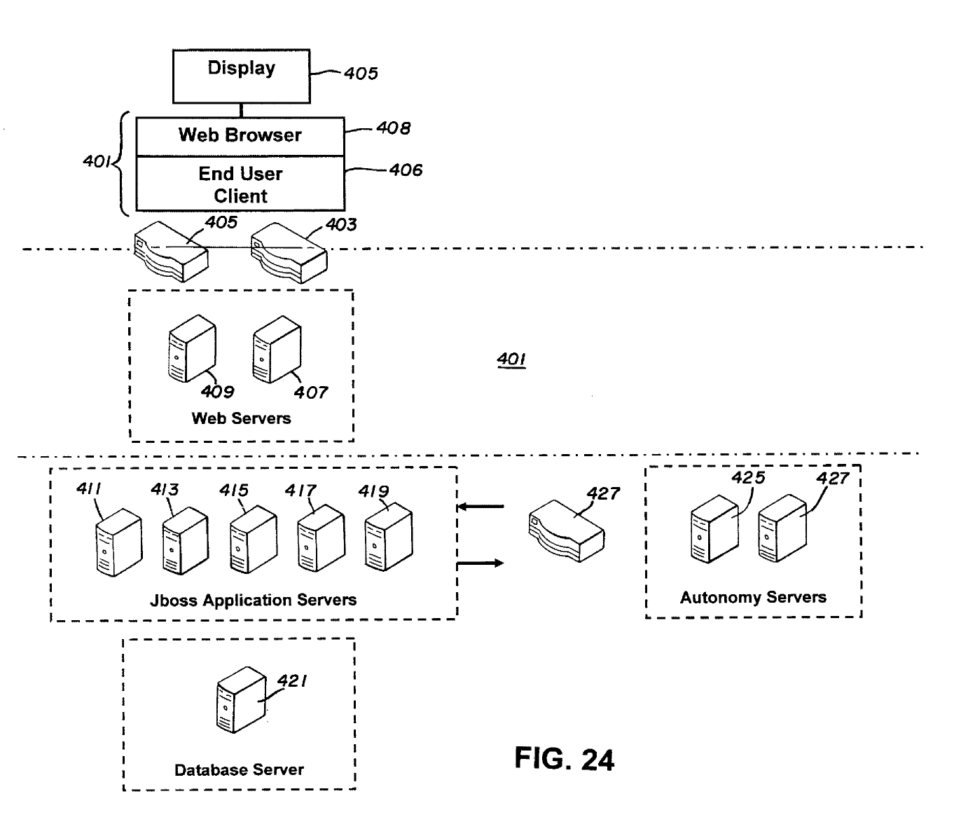

An illustrative embodiment of a website 401 for providing content to an end user as described above is shown in FIG. 24. The website 401 employs first and second load balancers 403, 405, which communicate with a pair of web servers 407, 409, for example, such as Apache web servers. The web servers 407, 409 further communicate with five application (Jboss) servers 411, 413, 415, 417, 419, which are arranged to access a database comprising digital storage media and database server 421. Additionally, the application servers, e.g. 411, may communicate through a load balancer 427 with first and second Autonomy Servers 425, 427.

The operation of the system of FIG. 24 may be illustrated as follows. The end user opens a browser on his computer, e.g. 401, and enters a request to visit http://www.behr.com. The request reaches the two Cisco load balancers 407, 409. One of the load balancers, e.g. 407, passes the request to one of two Apache web servers 407, 409. The Apache web server, e.g. 409, analyzes the request and determines if it can be handled locally, i.e. checks to see if the object exists in the server document root. Any portion of the request that can be fulfilled by the Apache server 409 is typically static content, i.e. .png, .jpg, .swf, .css, .js, .html, .txt, resident in digital storage on the server 409. Any portion of the request that can not be served by the Apache server 409 is passed back to the Jboss server, e.g. 411, for example, configured context roots, dynamic content, and processing requests such as a logon event. The application server 411 then processes the portion of the request forwarded to it. If additional data is needed from the database 421, for example, such as a username, password, or workbook, the application server 411 retrieves that data from the database 421. The application server 411 then sends processed data back out through the webserver 409 to the client 406 residing on the end user computer 401, in this case the web browser 408. Web browser 408 reassembles the data and renders the page in the browser, which causes display on the display apparatus 410 of the user's computer. The servers then wait for next request.

In one embodiment, in response to the user's initial access, a website (client) application is transmitted to the user's computer, e.g. 401, and runs in the browser of the user computer. In one embodiment, the website application is a SWF application which controls flash player animation on the user's display, for example, how various features animate in and out or fade in or out. The actual content of a particular page is pulled dynamically from the server system in response to user selection (“clicking”) operations. The web server supplies data comprising the XML code, which defines the active content to be displayed, to the user's flash player along with the static content, e.g. a home page project image in, for example, HTML format.

It will be appreciated that in one embodiment, the screens shown in FIGS. 2-23, may be web pages constructed using various markup languages (e.g., HTML, XML, XSL, Javascript) that allow for presentation of text, graphics, audio and video media, and other formats of informational data. These web pages can also provide a support environment for displaying additional technologies often referred to as active content that provides enhanced interaction with the delivered content versus the static content that is usually represented as text, graphics, audio, or video. A person with a computer and a software system referred to as a “browser” can connect to the network such as the Internet via a telephone line, DSL connection, or other means to gain access to the server and the web pages that deliver the active technologies and information and the accompanying ability to interact with the information and functionality presented.

As discussed above, in one embodiment, such web pages may be supplied using a server-client system comprising of server-based website operating over the Internet. As those skilled in the art appreciate, the Internet is comprised of a large number of computers and computer networks that are connected via various communications protocols (e.g., HTTP, FTP, POP3, SMTP) that utilize numerous technologies for delivering functionality to a client computer. The interconnected computers exchange information using various services including the World Wide Web (“WWW”). The WWW service allows a server computer and application to provide storage of files and manage the delivery of functionality predominately through what is referred to as web pages. Navigation to these unique web pages on the network is specified using a Uniform Resource Locator (“URL”) that identifies the computer server that stores the files and the name of the file of interest.

Thus, in one embodiment, the website may comprise a server engine comprising one or more computers, or servers, associated memory and server software such as a server operating system and server application programs. The website may communicate with the various user devices, which may provide the web pages for interactive operations with users via various forms of computer controlled displays or display devices.

In various embodiments, software, including, but not limited to, server software and operating systems or other software for implementing the disclosed processes and procedures may be stored on various forms of computer readable medium or media or computer readable storage medium or media.

For the purposes of this disclosure, a computer readable medium stores computer data, which data can and typically does include computer program code that is executable by a computer, in machine readable form. By way of example, and not limitation, a computer readable medium may comprise computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable storage media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other physical or material medium which can be used to tangibly store the desired information or data or instructions and which can be accessed by a computer or processor. In various embodiments, when suitable computer program code is loaded into and executed by a computer, the computer becomes a specially configured apparatus.

Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

1. A computerized method for assisting a user with color selection via selection operations performed on a computer controlled display comprising the steps of:
presenting the user with a first display screen, said first display screen comprising a home page having first, second, and third links located adjacent one another along an upper edge thereof, one of the first, second, and third links comprising an “expert picks” link responding to a user selection operation performed with respect to the “experts picks” link to cause generation of a drop down menu, the drop down menu comprising a plurality of room type links, respectively comprising individual links to one of six or more different room types;
responding to a user selection of one of said room type links to generate a display comprising a scene of the room type identified by the link and displaying beneath the scene a row of a plurality of color chips each having a different color,
wherein each of said color chips, when subjected to a touch or selection operation displays a “quick view” link;
responding to selection of said quick view link to generate a display comprising (a) a display of an enlarged color chip having the color of the chip on which the selected quick view link appeared, (b) an adjacent room scene, (c) a “view in a room” link being located beneath the adjacent room scene, and (d) a “buy now” link also appearing on said display; and
in response to selection of said “view in a room” link, generating a display of a “view in a room” display screen, said “view in a room” display screen comprising:
(a) a generally rectangular paint chip of the color initially selected for a “quick view” on the “expert picks” display screen;
(b) an interior room scene adjacent the color chip, wherein, one or more surfaces are shown painted with the color of the color chip;
(c) an exterior scene adjacent the interior scene wherein one or more exterior surfaces of a home image are painted with the color of the color chip; and
(d) a row of five interior thumb images and a row of five exterior thumb images disposed beneath the large interior and exterior images, each of the thumb images comprising a link, which when selected or “clicked on” causes the selected thumb image to replace the large image shown in one of the respective interior and exterior scenes.

2. Color selection apparatus comprising:
one or more computers interactively coupled to a computer controlled display apparatus and configured to perform the following operations:
presenting a user with a first display screen, said first display screen comprising a home page having first, second, and third links located adjacent one another along an upper edge thereof, one of the first, second, and third links comprising an “expert picks” link;
responding to a user selection operation performed with respect to the “experts picks” link to cause generation of a drop down menu, the drop down menu comprising a plurality of room type links, respectively comprising individual links to one of six or more different room types;
responding to a user selection of one of said room type links to generate a display comprising a scene of the room type identified by the link and displaying beneath the scene a row of a plurality of color chips each having a different color,
wherein each of said color chips, when subjected to a touch or selection operation displays a “quick view” link;
responding to selection of said quick view link to generate a display comprising (a) a display of an enlarged color chip having the color of the chip on which the selected quick view link appeared, (b) an adjacent room scene, (c) a “view in a room” link being located beneath the adjacent room scene, and (d) a “buy now” link also appearing on said display; and
in response to selection of said “view in a room” link, generating a display of a “view in a room” display screen, said “view in a room” display screen comprising:
(a) a generally rectangular paint chip of the color initially selected for a “quick view” on the “expert picks” display screen;
(b) an interior room scene adjacent the color chip, wherein, one or more surfaces are shown painted with the color of the color chip;
(c) an exterior scene adjacent the interior scene wherein one or more exterior surfaces of a home image are painted with the color of the color chip; and
(d) a row of five interior thumb images and a row of five exterior thumb images disposed beneath the large interior and exterior images, each of the thumb images comprising a link, which when selected or “clicked on” causes the selected thumb image to replace the large image shown in one of the respective interior and exterior scenes.

3. Computer software comprising computer readable program instructions or code stored on a tangible computer readable storage medium or media, which when executed by one or more computers or processors causes performance of the following operations:
presenting a user with a first display screen on a display apparatus, said first display screen comprising a home page having first, second, and third links located adjacent one another along an upper edge thereof, one of the first, second, and third links comprising an “expert picks” link responding to a user selection operation performed with respect to the “experts picks” link to cause generation of a drop down menu, the drop down menu comprising a plurality of room type links, respectively comprising individual links to one of six or more different room types;
responding to a user selection of one of said room type links to generate a display comprising a scene of the room type identified by the link and displaying beneath the scene a row of a plurality of color chips each having a different color,
wherein each of said color chips, when subjected to a touch or selection operation displays a “quick view” link;
responding to selection of said quick view link to generate a display comprising (a) a display of an enlarged color chip having the color of the chip on which the selected quick view link appeared, (b) an adjacent room scene, (c) a “view in a room” link being located beneath the adjacent room scene, and (d) a “buy now” link also appearing on said display; and
in response to selection of said “view in a room” link, generating a display of a “view in a room” display screen, said “view in a room” display screen comprising:
(a) a generally rectangular paint chip of the color initially selected for a “quick view” on the “expert picks” display screen;
(b) an interior room scene adjacent the color chip, wherein, one or more surfaces are shown painted with the color of the color chip;
(c) an exterior scene adjacent the interior scene wherein one or more exterior surfaces of a home image are painted with the color of the color chip; and
(d) a row of five interior thumb images and a row of five exterior thumb images disposed beneath the large interior and exterior images, each of the thumb images comprising a link, which when selected or “clicked on” causes the selected thumb image to replace the large image shown in one of the respective interior and exterior scenes.
